(19) United States
(12) Patent Application Publication
(10) Pub. No.: US 2025/0270716 A1
(43) Pub. Date: Aug. 28, 2025

(54) NANOSTRUCTURED ANODE FOR A WATER ELECTROLYZER

(71) Applicant: Smoltek AB, GÖTEBORG (SE)

(72) Inventors: Qi Li, GÖTEBORG (SE); Fabian Wenger, GÖTEBORG (SE)

(21) Appl. No.: 18/855,449

(22) PCT Filed: Apr. 14, 2023
(86) PCT No.: PCT/EP2023/059824

§ 371 Date: Oct. 9, 2024

(30) Foreign Application Priority Data
Apr. 28, 2022 (SE) 2250510-1

(51) Int. Cl. C25B 11/031; C25B 1/04; C25B 9/23; C25B 11/037; C25B 11/069

(52) U.S. Cl. CPC C25B 11/031; C25B 1/04; C25B 9/23; C25B 11/037; C25B 11/069

(57) ABSTRACT

A transport layer arrangement for the anode of a proton exchange membrane water electrolyzer, where the transport layer arrangement comprises a porous layer and a plurality of elongated nanostructures. Each elongated nanostructure is attached to a first surface of the porous layer at one end of the elongated nanostructure. The plurality of elongated nanostructures is covered by a coating comprising a first layer, which in turn comprises a non-noble metal oxide.

### TECHNICAL FIELD

The present disclosure relates to devices used in electrolysis, particularly for the electrolysis of water.

### BACKGROUND

The production of hydrogen gas through the electrolysis of water is a promising technology both for replacing the production of hydrogen gas from fossil fuels and as a means of converting excess electrical energy from intermittent energy sources such as solar and wind power to chemical energy for storage. However, existing water electrolyzers suffer from problems related to the corrosive conditions within the electrolysis cell and the use of expensive catalysts. For electrolysis cells comprising ion exchange membranes it may be necessary to use catalysts comprising e.g., platinum or iridium, which entails a significant cost. This is especially the case at the anode side of ion exchange membrane electrolyzers, where the combination of an acidic environment and high electrical potential require the use of highly chemically stable materials.

WO 2016/191057 A1 discloses an anode for a water electrolyzer.

Still, there is a need for improved water electrolyzer anodes.

### SUMMARY

It is an object of the present disclosure to provide improved electrodes for water electrolyzers, which, i.a., offer the benefit of being more durable and efficient.

This object is at least in part obtained a transport layer arrangement for the anode of a proton exchange membrane (PEM) water electrolyzer. The transport layer arrangement comprises a porous layer and a plurality of elongated nanostructures. Each elongated nanostructure is attached to a first surface of the porous layer at one end of the elongated nanostructure and the plurality of elongated nanostructures is covered by a coating. The coating comprises a first layer comprising a non-noble metal oxide.

Due to the harsh chemical conditions at the anode of a PEM water electrolyzer, it is difficult to find a catalyst support that is sufficiently chemically stable. The abovementioned transport layer arrangement is intended to be arranged with the first side of the porous layer facing the ion exchange membrane of the water electrolyzer. This enables the plurality of elongated nanostructures to connect the anode-side electrocatalyst to the porous layer mechanically and electrically, thereby serving as a catalyst support. The use of a catalyst support makes it possible to reduce the amount of electrocatalyst used, which is an advantage.

Non-noble metal oxides are among the materials found to be sufficiently chemically stable for use on the anode side of PEM electrolyzers. Using a coating comprising a non-noble metal oxide therefore shields the underlying plurality of elongated nanostructures from the corrosive effect of the chemical environment. This can improve the durability of the transport layer arrangement. The non-noble metal oxide in the first layer may for example comprise any of tantalum oxide, hafnium oxide, antimony oxide, titanium oxide, tin oxide, and niobium oxide. Optionally, the first layer may comprise manganese oxide. Advantageously, these oxides have previously been shown to be chemically stable under the conditions found at the anode of a PEM electrolyzer.

According to some aspects, the first layer may comprise more than one non-noble metal oxide. For example, the first layer may comprise both tantalum oxide and hafnium oxide, or both tin oxide and tantalum oxide, or a combination of hafnium oxide, tin oxide, and tantalum oxide.

The first layer of the coating may also comprise a dopant arranged to increase an electrical conductivity of the non-noble metal oxide comprised in the first layer. Dopants are, in this context, elements that would not be present in the non-noble metal oxide in its pure form and which affect the electrical conductivity of the non-noble metal oxide by acting as electron donors or electron acceptors. Increasing the electrical conductivity of the non-noble metal oxide leads to improved electron transport between the electrocatalyst and the porous layer, which is an advantage. As an example, the dopant may comprise any of aluminum, hafnium, zirconium, iridium, and titanium.

The first layer has an inner surface facing towards the plurality of elongated nanostructures and an outer surface facing away from the plurality of elongated nanostructures. The concentration of the dopant may be higher at the inner surface than at the outer surface, particularly if the dopant element is not catalytically active in the oxygen evolution reaction. Advantageously, this can improve the electron transport between the coating and the plurality of elongated nanostructures.

The electrical conductivity of a non-noble metal oxide can also be increased by introducing other point defects such as vacancies or interstitials into the oxide, or by making the oxide non-stoichiometric. Accordingly, the non-noble metal oxide comprised in the first layer may be non-stoichiometric. In particular, the non-noble metal oxide may be oxygen deficient compared to the stoichiometric composition.

According to some aspects, a thickness of the first layer may be less than 5 nm or less than 3 nm. If the first layer is thin, electron transport through the layer may occur through mechanisms such as electron hopping. Electron transport may also occur through the formation of conductive regions in the non-noble metal oxide when the first layer is exposed to an electrical potential.

According to some aspects, the coating may comprise an inner layer arranged between the plurality of elongated nanostructures and the first layer. The inner layer may be arranged to ensure that the plurality of elongated nanostructures is fully covered by the coating, which is advantageous as it prevents degradation of the elongated nanostructures. Alternatively, the inner layer may be arranged to improve electron transport between the coating and the plurality of elongated nanostructures. For example, the inner layer may comprise a material arranged to affect the electron band structure of the non-noble metal oxide comprised in the first layer.

As an alternative, the inner layer may be divided into one or more sub-layers comprising different materials. For example, a sub-layer arranged facing the plurality of elongated nanostructures may comprise a non-noble metal oxide, while a sub-layer arranged facing the first layer may comprise a material with high electrical conductivity. Advantageously, this arrangement may allow electrons to tunnel through the coating without compromising the extent to which the elongated nanostructures are covered by the coating.

The first layer of the coating may also comprise a noble metal oxide, preferably a noble metal oxide comprising a platinum-group metal. The noble metal oxide comprised in the first layer may for example comprise any of iridium oxide, ruthenium oxide, and platinum oxide. Advantageously, platinum-group oxides can act as electrocatalysts for the oxygen evolution reaction that occurs on the anode side of a PEM electrolyzer. Since the electrocatalyst must be in contact with the surrounding environment, particularly the ion exchange membrane, it is an advantage if the concentration of the noble metal oxide is higher at the outer surface of the first layer than at the inner surface of the first layer.

The first layer may also comprise more than one noble metal oxide. As an example, the first layer may comprise both iridium oxide and ruthenium oxide.

The coating may also comprise an outer layer arranged on the outer surface of the first layer, and the outer layer may comprise a noble metal oxide. In particular, the outer layer may comprise an oxide that can function as an electrocatalyst, such as any of iridium oxide, ruthenium oxide, and platinum oxide. The outer layer may also comprise several different oxides that function as an electrocatalyst, e.g., the outer layer may comprise both iridium oxide and ruthenium oxide. Advantageously, if the electrocatalyst is comprised in an outer layer of the coating, it can be in good electrical and mechanical contact with the plurality of elongated nanostructures and the porous transport layer while simultaneously being in contact with the ion exchange membrane. This can lead to more efficient electrolyzer operation. Optionally, the outer layer may comprise a plurality of nanoparticles.

In order to provide good electrical contact between the electrocatalyst and the porous layer, the plurality of elongated nanostructures should preferably comprise a conductive material. Carbon materials have good electrical conductivity and are frequently used in electrochemical cells. Thus, the plurality of elongated nanostructures may comprise elongated carbon nanostructures. For example, the plurality of elongated nanostructures may comprise any of carbon nanofibers, carbon nanotubes, carbon nanowires, and carbon nanowalls.

The elongated nanostructures may extend generally along respective axes, where the axes are oriented in parallel to each other and extend perpendicularly to the porous layer. Advantageously, this vertical orientation can simplify application of the coating and allow for greater control of the position of the plurality of elongated nanostructures relative to the electrolyzer membrane.

The porous layer may comprise a porous metallic material that is sufficiently chemically stable to be used on the anode side of a PEM electrolyzer. As an example, the porous metallic material may be a titanium mesh, or a titanium fiber felt.

There is also herein disclosed an electrolyzer comprising a first electrode, a second electrode, and an ion exchange membrane arranged between the first and the second electrode. Each electrode comprises an electrocatalyst layer arranged facing the ion exchange membrane, a transport layer arranged facing the respective electrocatalyst layer, and a separator element arranged facing the respective transport layer. Here, at least one of the first and second electrodes comprises a transport layer arrangement as previously described.

In the electrolyzer, the transport layer arrangement is arranged so that the first surface, to which the plurality of elongated nanostructures is attached, faces the ion exchange membrane. This allows the plurality of elongated nanostructures to act as a catalyst support, which advantageously improves the electrical contact between the electrocatalyst and the porous layer and can make it possible to use a lower catalyst load.

At least some of the elongated nanostructures comprised in the transport layer arrangement may extend past the surface of the ion exchange membrane, which improves the contact between the electrocatalyst and the ion exchange membrane. This can lead to more efficient use of the electrocatalyst, which is an advantage.

Furthermore, there is herein disclosed a method for producing a transport layer arrangement for the anode of a proton exchange membrane water electrolyzer. The transport layer arrangement comprises a porous layer. The method comprises generating a plurality of elongated nanostructures, where each elongated nanostructure is attached to a first surface of the porous layer at one end of the elongated nanostructure. The method also comprises depositing a coating on the plurality of elongated nanostructures, wherein the coating comprises a first layer comprising a non-noble metal oxide.

According to some aspects, generating a plurality of elongated nanostructures comprises growing the elongated nanostructures on the first surface of the porous layer. Advantageously, this attaches the elongated nanostructures to the first surface.

According to other aspects, generating a plurality of elongated nanostructures comprises growing the elongated nanostructures on a growth substrate and subsequently transferring the elongated nanostructures to the first surface of the porous layer. This has the advantage of making it possible to select an optimal growth substrate.

Growing the elongated nanostructures either on the porous layer or on a separate growth substrate has the advantage of making it possible to tune properties of the plurality of elongated nanostructures, such as the size and shape of the nanostructures and the spacing between nanostructures.

According to one example, depositing of the coating on the plurality of elongated nanostructures is carried out using atomic layer deposition or electroless nanoplating. Advantageously, this enables the coating to conform to the contour of the plurality of elongated nanostructures and the first surface of the porous layer.

Depositing the coating layer on the plurality of elongated nanostructures may comprise depositing a dopant element in the first layer, the dopant element being arranged to increase an electrical conductivity of the non-noble metal oxide. This has the advantage of producing a coating with improved electron transport.

The first layer has an inner surface facing towards the plurality of elongated nanostructures and an outer surface facing away from the plurality of elongated nanostructures. According to aspects, the concentration of the dopant may be higher at the inner surface than at the outer surface. Advantageously, this may improve electron transport between the coating and the plurality of elongated nanostructures.

Depositing the coating layer on the plurality of elongated nanostructures may comprise depositing a noble metal oxide in the first layer. The noble metal oxide may advantageously serve as an electrocatalyst for the oxygen evolution reaction. The concentration of the noble metal oxide may be higher at the outer surface than at the inner surface. This increases efficiency as the noble metal oxide must be exposed to water and to the ion exchange membrane in order to function as an electrocatalyst.

Alternatively, depositing the coating on the plurality of elongated nanostructures may comprise depositing an outer layer on the first layer, where the outer layer comprises a noble metal oxide. As above, the noble metal oxide can act as an electrocatalyst.

According to aspects, depositing the coating comprises depositing an inner layer arranged between the first layer and the plurality of elongated nanostructures. Optionally, depositing the inner layer entails depositing one or more sub-layers comprising different materials. The inner layer can be selected to improve electron transport through the coating and/or between the coating and the plurality of elongated nanostructures, which is an advantage.

The method may also comprise a thermal treatment of the transport layer arrangement, wherein the transport layer arrangement is for example exposed to high temperatures during extended periods of time in the presence of an inert gas. Advantageously, this thermal treatment can allow dopants to diffuse through the layers and helps achieve a uniform dopant distribution.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where:

FIG. 1 schematically illustrates a water electrolyzer;

FIG. 2 schematically illustrates a transport layer arrangement;

FIG. 3A, B, C, and D schematically illustrate elongated nanostructures on a substrate;

FIG. 4 schematically illustrates a transport layer arrangement and an ion exchange membrane;

FIG. 5 is a flow chart illustrating methods; and

FIG. 6 schematically illustrates catalyst particles on a catalyst support.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

The following description relates to electrodes for electrochemical cells, with a focus on water electrolyzers using proton exchange membranes. However, a person skilled in the art realizes that the methods and devices herein are also applicable to other types of electrolyzers, such as alkaline electrolyzers or electrolyzers comprising anion exchange membranes. The methods and devices can also be applied to other electrochemical cells such as fuel cells.

Water electrolyzers use electrical energy to split water into oxygen gas and hydrogen gas. An electrolyzer comprises two electrodes, one of which is the positively charged anode and the other of which is the negatively charged cathode. The electrolyzer also comprises a medium which allows for transport of ions, known as an electrolyte. The electrodes are connected to a power supply which provides electrical energy, driving the electrolysis reaction.

In some electrolyzers, a solid electrolyte such as an ion exchange membrane is used as the ion transport medium. An ion exchange membrane is a solid material that can transport some dissolved ions, while simultaneously blocking other ions or neutral molecules. Since this material conducts ions, it can also be known as an ionic conductor. Use of ion exchange membranes allows for a compact electrolyzer design, as well as good separation of oxygen and hydrogen gas, which is an advantage.

The ion exchange membranes used in water electrolyzers can be categorized according to the ionic species moving through the membrane. Anion exchange membranes, AEM, conduct the negative anion, in this case the hydroxide ion, from the cathode to the anode. Proton exchange membranes, PEM, conduct the positive hydrogen ion or proton from the anode to the cathode. Both anion and proton exchange membranes can be permeable to water but must minimize the amount of hydrogen and/or oxygen gas that travels between the electrodes. Ion exchange membranes can for example comprise polymers such as sulfonated tetrafluoroethylene, also known as Nafion, or polymers based on polysulfone or polyphenole oxide.

In a water electrolyzer comprising ion exchange membranes, each electrode generally comprises an electrocatalyst layer arranged next to a surface of the ion exchange membrane and a porous layer arranged next to the electrocatalyst layer. In most electrolyzers there is also a conductive element or conductive plate arranged adjacent to the porous layer on the side facing away from the electrocatalyst layer and the ion exchange membrane. This conductive element is in electrical contact with the power source.

Thus, in a water electrolyzer comprising a PEM, also known as a PEM water electrolyzer or PEMWE, water enters the electrolyzer on the side of the ion exchange membrane where the anode is located. The water molecules undergo the oxygen evolution reaction at the anode-side electrocatalyst layer:

2H₂O→4H⁺+O₂+4e⁻.

The resulting electrons will pass via the porous layer and the conductive element to enter the circuit connecting the two electrodes. The oxygen gas leaves the electrolyzer, and the positive hydrogen ions (protons) will diffuse across the PEM to the cathode side and the cathode electrocatalyst layer, where they undergo the hydrogen evolution reaction:

4H⁺+4e⁻→2H₂.

The electrocatalyst layer comprises a catalytically active material, i.e. a material or chemical compound that facilitates a chemical reaction by lowering the amount of energy needed for the chemical reaction to occur. The electrocatalyst comprised in an electrocatalyst layer facilitates the chemical reactions comprised in the electrolysis process, such as the oxygen evolution reaction taking place at the anode side or the hydrogen evolution reaction taking place at the cathode side.

The choice of electrocatalyst depends on, among other things, the chemical reaction taking place and the need for chemical stability under the conditions at the respective electrode. On the cathode side of PEM water electrolyzers, platinum-group metals such as platinum or palladium are frequently used due to their high catalytic activity with regard to the hydrogen evolution reaction. On the anode side, it is common to use oxides of platinum-group metals, e.g. iridium oxide, ruthenium oxide or platinum oxide. The chemical conditions at the anode side are more corrosive than at the cathode side due to a combination of an acidic environment and a high electrical potential that is necessary to drive the electrolysis reaction. In addition to high catalytic activity with regard to the oxygen evolution reaction, the anode-side electrocatalyst must therefore also be chemically stable under such conditions.

The electrocatalyst layer may also comprise catalyst supports on which the electrocatalyst material is deposited. As an example, cathode-side electrocatalysts in PEMWE often comprise carbon nanostructures or carbon black, on which an electrocatalyst such as platinum is deposited in the form of nanoparticles. In order for the electrolysis reaction to proceed the electrocatalysts must be in electrical contact with the porous layer and the conductive element, so it is advantageous if the catalyst support is electrically conductive. The catalyst support can then provide an electrical connection between the electrocatalyst and other components such as the porous layer.

On the anode side, catalyst supports can comprise metals such as titanium or metal oxides such as titanium oxide. Metal oxides may have insufficient electrical conductivity to provide an electrical connection between the electrocatalyst and the porous layer, in which case the electrocatalyst itself is often used to form the electrical connection. This requires a larger amount of electrocatalyst per unit area of the electrolyzer, i.e. a higher catalyst load, and leads to higher costs. The anode-side electrocatalyst can even be used without a catalyst support, but this also requires a higher catalyst load.

The porous layer may also be referred to as a porous transport layer (PTL), mass transport layer, gas diffusion layer (GDL), current collector, or just diffusion layer. Its function is to allow transport of reactants and products, i.e. water, oxygen gas, and hydrogen gas, to and from the electrocatalyst layers while simultaneously maintaining electrical contact between the electrocatalyst layer and the conductive element that is connected to the power source. Common PTL materials for the cathode side are carbon paper or carbon cloth, while on the anode side porous metallic materials such as a titanium fiber felt or a titanium mesh are often used.

The conductive element may also be known as a separator element, separator plate, or flow plate. If the electrolyzer cell is part of a stack of electrolyzer cells arranged in series, a conductive element may serve as the anode-side conductive element for one electrolyzer cell and as the cathode-side conductive element for a neighboring electrolyzer cell. In this case it may be referred to as a bipolar plate.

The conductive elements comprise conductive materials that can withstand the chemical environment in the electrolyzer. For example, a conductive element may be a steel element coated with one or a combination of titanium, tungsten, and zirconium. A conductive element may also comprise a carbon composite material.

Herein, a conductive material, element, or component is a material, element, or component with high electric conductivity. A high electric conductivity could be an electric conductivity normally associated with metallic or semiconducting materials, or an electric conductivity of more than 100 (Ωm)⁻¹.

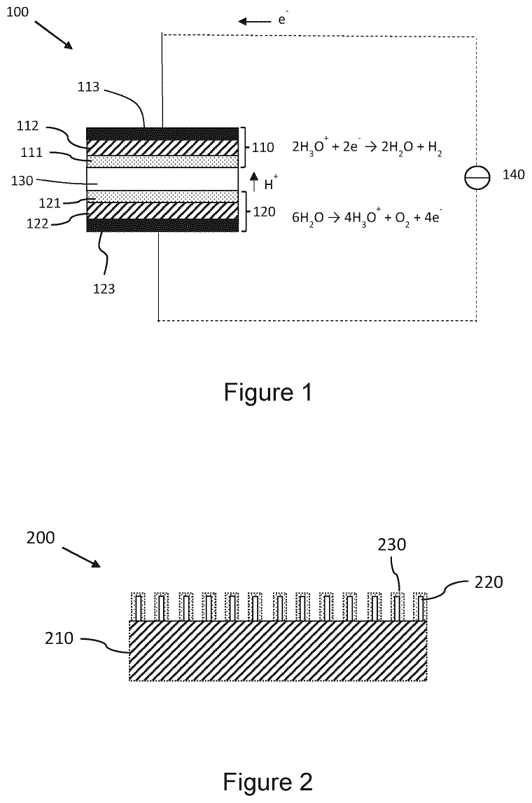

FIG. 1 shows an electrolyzer 100 comprising a first electrode 110 and a second electrode 120 and an ion exchange membrane 130 arranged in-between the first and the second electrode. Each electrode comprises a conductive element 113, 123, and an electrocatalyst layer 111, 121, the catalyst layer being arranged in close contact with the ion exchange membrane 130. Each electrode also comprises a porous transport layer 112, 122 arranged between the conductive element 113, 123 and the electrocatalyst layer 111, 121. Both conductive elements 113, 123 are connected to a power source 140.

For an improved anode construction, it is desirable to find a support for the anode catalyst that is chemically stable, sufficiently electrically conductive, and in good mechanical and electrical contact with the porous transport layer.

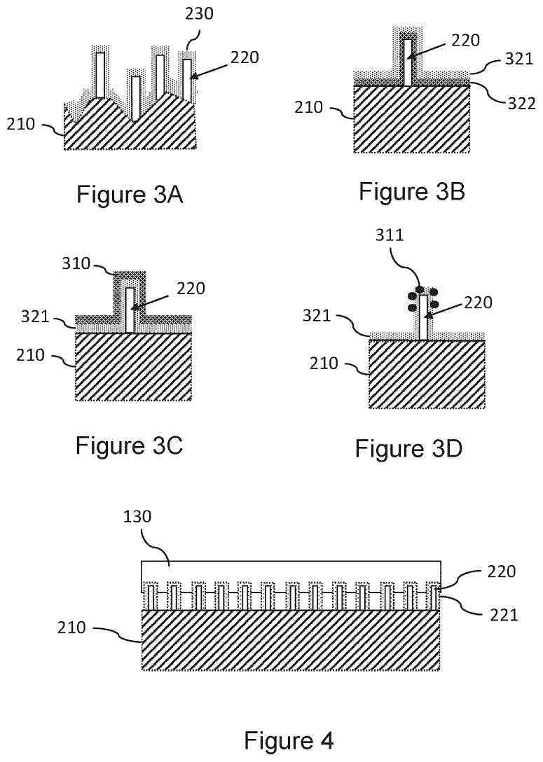

FIG. 2 shows a transport layer arrangement 200 for the anode of a proton exchange membrane water electrolyzer 100 like the one seen in FIG. 1. The transport layer arrangement 200 comprises a porous layer 210 and a plurality of elongated nanostructures 220. Each elongated nanostructure 220 is attached to a first surface of the porous layer 210 at one end of the elongated nanostructure. Furthermore, the plurality of elongated nanostructures 220 is covered by a coating 230, which comprises a first layer comprising a non-noble metal oxide. The first layer 321 is shown in more detail in FIGS. 3A, 3B, 3C and 3D.

In an electrolyzer, the transport layer arrangement 200 would be arranged with the first surface of the porous layer 210 facing the ion exchange membrane 130. The plurality of elongated nanostructures 220 would therefore serve as a catalyst support.

The porous layer 210 comprises an electrically conductive material with high enough porosity to allow mass transport of the reactants and products of the electrolysis reaction, as discussed above. For example, the porous layer 210 may comprise a porous metallic material. In particular, the porous layer 210 may comprise a titanium mesh, a titanium fiber felt, or sintered titanium powder.

A nanostructure is a structure having a size that is substantially smaller than one micrometer, and preferably between 1 and 100 nm, in at least one dimension. Herein, an elongated nanostructure is a nanostructure that is substantially larger in at least one dimension, such as length, compared to another dimension such as width.

As an example, consider a substantially cylindrical nanostructure characterized by a length and a diameter. The nanostructure may be considered elongated if the length is significantly larger than the diameter, e.g., if the length is more than twice as large as the diameter. Similar reasoning may be applied to nanostructures that are substantially conical, frustoconical, rectangular, or of arbitrary shape.

The elongated nanostructures may for example be straight, spiraling, branched, wavy or tilted. Optionally, they are classifiable as nanowires, nano-horns, nanotubes, nanowalls, crystalline nanostructures, or amorphous nanostructures.

An elongated nanostructure is considered to be attached to the porous layer if it is in contact with a section of the surface of the porous layer 210 and remains in contact with the same section of the surface during operation of the electrolyzer. For example, there may be a chemical bond between the nanostructure and the porous layer 210. The chemical bond may be a covalent bond.

The surface of the porous layer 210 will in general display a substantial degree of surface roughness or unevenness. That is, the surface will display surface features such as ridges, bumps, troughs, and holes. An elongated nanostructure 220 may be attached to any section of the surface, in a trough or hole as well as on a ridge or bump. It may be noted that a size of the surface features can be larger than a size of the nanostructures, e.g. a hole may be several micrometers wide while the nanostructures have a width of 50 to 100 nanometers.

The coating 230 is arranged to prevent degradation of the plurality of elongated nanostructures by the harsh chemical environment at the anode. It is known that non-noble metal oxides can be chemically stable in such an environment. In the field of chemistry, noble metals are conventionally defined as metals that do not react easily with many molecules typically present in ambient atmosphere. Noble metals are generally understood to include ruthenium, rhodium, palladium, osmium, iridium, platinum, gold, and silver. Non-noble metals are thus the metals not included in the group of noble metals. The non-noble metal oxide comprised in the first layer 321 can for example comprise any of tantalum oxide, hafnium oxide, antimony oxide, titanium oxide, tin oxide, and niobium oxide. The non-noble metal oxide may also comprise manganese oxide. The first layer can also comprise more than one non- noble metal oxide. For example, the first layer can comprise both tantalum oxide and hafnium oxide, or both tantalum oxide and tin oxide.

For the plurality of elongated nanostructures 220 to be covered by the coating 230 is taken to mean that the coating 230 covers at least part of the surface of the elongated nanostructures 220, preferably more than 90% of the surface. As the coating 230 serves to protect the underlying elongated nanostructures 220 from chemical degradation, it is an advantage if the surface or the elongated nanostructures 220 is fully covered by the coating 230, preventing the exposure of even small sections of the surface to the surrounding chemical environment and thereby increasing the durability of the transport layer arrangement.

Ensuring that the elongated nanostructures 220 are fully covered by the coating 230 may require the first layer to be of a certain thickness. As an example, the first layer may be between 50 and 100 nm thick.

In general, there will be some parts of the first surface of the porous layer 210 that are not covered by the elongated nanostructures 220. For example, there may be a distance between individual elongated nanostructures 220, leaving the first surface of the porous layer 210 uncovered between them. The distance between nanostructures may for example be 50 nm, 100 nm, or 200 nm.

In this case, the coating 230 may extend also to the first surface of the porous layer 210 where it is not covered by the elongated nanostructures 220. According to some aspects, the exposed sections of the first surface of the porous layer 210 may be fully covered by the coating 230 as shown e.g. in FIGS. 3A, 3B, 3C and 3D. According to other aspects, the exposed sections of the first surface may be only partially covered by the coating 230. This may especially be the case if the material of the porous layer is in itself resistant to the chemical environment at the anode.

The coating 230 should preferably conform to the contours of the elongated nanostructures 220, and optionally also to the contours of the parts of the first surface of the porous layer 210 that are covered by the coating, as illustrated in FIG. 3A.

In addition to chemical stability, the coating 230 must also be sufficiently electrically conductive to transport electrons from the anode-side electrocatalyst into the porous layer. A pure non-noble metal oxide in its stoichiometric composition may not have a sufficiently high electrical conductivity. In this case it may be necessary to increase the electrical conductivity, e.g. by altering the composition and structure of the non-noble metal oxide.

One method for altering the electrical conductivity of a material is through the introduction of dopants. Dopants, in this case, are atoms of an element that would not normally be present in the material and therefore constitute an impurity that alters the electron structure of the material. Doping is known from the field of semiconductors, where dopants are used to increase electrical conductivity either by introducing additional electrons, known as n-type doping, or by introducing so-called electron holes, which is known as p-type doping.

Thus, to increase electric conductivity in the coating 230, the first layer 321 of the coating 230 may comprise a dopant arranged to increase an electrical conductivity of the non-noble metal oxide. The dopant atom may be selected in dependence of which non-noble metal oxides are present in the first layer 321, the material of the elongated nanostructures 220, and whether n-type or p-type doping is desired. For example, the dopant may be any of aluminum, hafnium, zirconium, iridium, and titanium. According to some aspects, the dopant may constitute between 10 and 25 mol % of the non-noble metal oxide. According to other aspects, the dopant may constitute between 30 and 50 mol % of the non-noble metal oxide. The higher interval is suitable for promoting the formation of conductive regions when the first layer is exposed to an electrical potential.

If the electrical conductivity of the elongated nanostructures 220 is different from that of the non-noble metal oxide comprised in the first layer 321, the transport of electrons across the boundary between the first layer 321 and the elongated nanostructures 220 may be impeded. As an example, if the elongated nanostructures comprise carbon materials or metals such as titanium, the electrical conductivity of the elongated nanostructures 220 is likely to be higher than that of the non-noble metal oxide. This can lead to the formation of a Schottky barrier, which can block electron transport across the interface in one direction.

To mitigate such issues, it can be an advantage to adjust the conductivity of the first layer 321 such that it is higher closer to the surface of the elongated nanostructures 220. Put another way, the first layer 321 has an inner surface facing towards the plurality of elongated nanostructures 220 and an outer surface facing away from the plurality of elongated nanostructures 220. The concentration of the dopant may be higher at the inner surface than at the outer surface, in order to achieve a higher electrical conductivity close to the surface of the elongated nanostructures 220. Optionally, the concentration of the dopant may be decreased gradually from the inner surface to the outer surface to form a dopant concentration gradient. This is advantageous in cases where the dopant is not catalytically active in the oxygen evolution reaction but is only arranged to increase the electrical conductivity. That is, if the dopant is not a platinum-group metal such as iridium.

Dopants constitute one type of point defects in solid materials. Other types of point defects such as vacancies and interstitials may also affect the electrical conductivity of a material, functionally acting as n-or p-type dopants. A vacancy in this case is when a lattice site that is occupied by an atom or ion in the defect-free material is instead empty. An interstitial is an atom situated between the lattice sites.

The presence of vacancies and interstitials can contribute to a departure from the stoichiometric composition of the oxide. Therefore, to increase the electrical conductivity of the coating 230 the non-noble metal oxide comprised in the first layer 321 may be non-stoichiometric. For several non-noble metal oxides, e.g. titanium oxide and tantalum oxide, the presence of oxygen vacancies in particular has been shown to increase electrical conductivity. The non-noble metal oxide may thus be oxygen deficient compared to the stoichiometric composition. Such oxygen-deficient metal oxides are sometimes referred to as suboxides.

According to aspects, the concentration of oxygen vacancies in an oxygen deficient non-noble metal oxide may be up to 5%. According to other aspects, between 10 and 25% of the oxygen sites in an oxygen deficient non-noble metal oxide may be vacant.

Optionally, the non-noble metal oxide may have a higher degree of non-stoichiometry at the inner surface of the first layer than at the outer surface.

It may be noted that, as the reaction taking place at the anode is the oxygen evolution reaction, there may be an exchange of oxygen between the non-noble metal oxide and the surrounding environment during electrolyzer operation. However, as the oxygen evolution reaction continuously produces oxygen gas that is subsequently transported away, it is expected that the oxygen deficiency of a suboxide comprised in the coating 230 can be maintained.

According to some aspects, the first layer 321 may be thin enough that conductive regions will form in the non-noble metal oxide under the influence of the electrical potential applied to the electrolyzer anode during operation. Conductive regions can form in oxides through creation and accumulation of point defects such as interstitials and vacancies. This effect is known e.g. from the field of resistive random access memory construction, where it can be referred to as a soft breakdown or as electroforming.

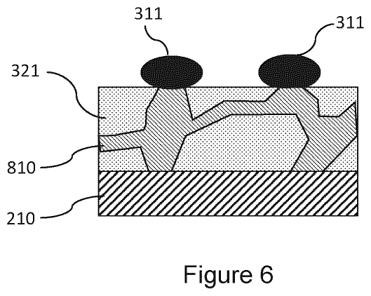

The conductive regions may also form a network within the first layer 321. FIG. 6 schematically illustrates an example of this, wherein nanoparticles 311 of a noble metal oxide are supported on a first layer 321 comprising a non-noble metal oxide, which in turn is arranged on a substrate 210. Conductive regions 810 connect the nanoparticles 311 to the substrate 210 and form a network providing electrical conductivity throughout the first layer 321 in both the horizontal and vertical direction. The noble metal oxide of the nanoparticles 311 may for example be iridium oxide, ruthenium oxide, platinum oxide, or a combination of these oxides.

According to another example, the first layer 321 may be thin enough that electron transport can occur through electron hopping conductivity. Electron hopping refers to a thermally activated process wherein an electron jumps from one site to another in a material that otherwise has low electrical conductivity. This mechanism can contribute significantly to electron transport in sufficiently thin layers. For instance, a thickness of the first layer 321 may be less than 5 nm, in order to allow for the formation of conductive regions, or less than 3 nm to allow for electron hopping conductivity.

In some cases, the coating 230 may comprise an inner layer 322 arranged between the plurality of elongated nanostructures 220 and the first layer 321. This is shown schematically in FIG. 3B.

The inner layer 322 can be arranged to provide improved coverage of the elongated nanostructures 220, for example if the thickness of the first layer 321 is insufficient to ensure that the elongated nanostructures are fully covered by the coating 230. The inner layer can also be arranged to improve the electron transport between the first layer 321 and the plurality of elongated nanostructures 220, for example by mitigating the formation of Schottky barriers as described above. To achieve this, the inner layer 322 may comprise a material arranged to affect the electron band structure and Fermi level of the non-noble metal oxide comprised in the first layer 321. In this case, a material comprised in the inner layer 322 may be selected in dependence of its work function relative to that of the non-noble metal oxide comprised in the first layer 321. The material comprised in the inner layer may for example be a metal such as aluminum, titanium, tungsten, or molybdenum, or a metal nitride such as titanium nitride, aluminum nitride, tungsten nitride, or molybdenum nitride.

The inner layer 322 may also comprise a non-noble metal oxide of a different kind than the one comprised in the first layer 321, or a non-noble metal oxide that is more non-stoichiometric or has a higher degree of doping compared to the non-noble metal oxide comprised in the first layer 321.

The inner layer 322 may also be divided into one or more sub-layers comprising different materials, where the sub-layers are used to promote electron transport mechanisms such as electron hopping or the formation of conductive regions that depend on the thickness of layers with low electrical conductivity. For example, the inner layer 322 may comprise two sub-layers, where a sub-layer arranged facing the plurality of elongated nanostructures 220 comprises a non-noble metal oxide and another sub-layer arranged facing the first layer 321 comprises a material with high electrical conductivity.

The sub-layer comprising a non-noble metal oxide should be thin enough to allow electron hopping and/or electron transport due to formation of conductive regions in the non-noble metal oxide. For example, it may be between 3 and 5 nm thick. The material with high electrical conductivity, positioned between the first layer and the sub-layer comprising a non-noble metal oxide, enables electron hopping through the non-noble metal oxide. The material with high electrical conductivity may for example be a metal, or another material with an electrical conductivity similar to that of a metal. It should be noted that more sub-layers can be added, as long as every other sub-layer comprises a non-noble metal oxide and the remaining sub-layers comprise a material with high electrical conductivity.

As previously mentioned, the first surface of the porous layer 210 is to be arranged facing the ion exchange membrane in the electrolyzer, so that the plurality of elongated nanostructures 220 can serve as catalyst supports. According to some examples, it is also possible to incorporate the electrocatalyst into the coating 230, which would have the advantage of further improving electrical and mechanical contact between the electrocatalyst and the porous transport layer. The anode-side electrocatalyst in a PEM electrolyzer typically comprises oxides of noble metals, so the first layer 321 may also comprise a noble metal oxide, preferably an oxide of a platinum-group metal. For example, the noble metal oxide comprised in the first layer 321 may comprise any of iridium oxide, ruthenium oxide, and platinum oxide. Generally, iridium oxide is the preferred electrocatalyst for the oxygen evolution reaction in PEM electrolyzers. However, the first layer may also comprise more than one noble metal oxide, e.g. it may comprise both iridium oxide and ruthenium oxide.

In order to act as an electrocatalyst, the noble metal oxide must be in contact with the surrounding environment, particularly the incoming water and the ion exchange membrane. It is therefore an advantage if the noble metal oxide is concentrated to the outer surface of the first layer 321, which faces away from the plurality of elongated nanostructures 220. That is, the concentration of the noble metal oxide may preferably be higher at the outer surface than at the inner surface. For example, the concentration of the noble metal oxide may be between 10 and 50 mol % at the outer surface.

Another alternative is to arrange the noble metal electrocatalyst on the outer surface of the first layer 321. That is, the coating 230 may comprise an outer layer 310 arranged on the outer surface of the first layer 321, where the outer layer 310 comprises a noble metal oxide functioning as an electrocatalyst. As above, the noble metal oxide preferably comprises a platinum group oxide such as any of iridium oxide, ruthenium oxide, and platinum oxide. The noble metal oxide may also comprise a combination of several platinum group oxides, such as a combination of iridium oxide and ruthenium oxide. Such an outer layer 310 is schematically illustrated in FIG. 3C.

The electrocatalysts used in electrolyzers are frequently in the form of nanoparticles, as nanoparticles of certain sizes display higher catalytic activity compared e.g. to larger particles. The outer layer 310 may therefore comprise a plurality of nanoparticles 311, where the nanoparticles comprise a noble metal oxide. This is schematically illustrated in FIG. 3D. The nanoparticles may for example have a size of between 2 and 5 nanometers.

The plurality of elongated nanostructures 220 should preferably comprise an electrically conductive material, that is, a material with an electrical conductivity similar to that of a metal or semiconductor, in order to improve the electrical connection between the electrocatalyst and the porous layer 210. Accordingly, the elongated nanostructures 220 may comprise materials such as metals, metal alloys, and semiconductors.

Carbon materials generally display good electrical conductivity and are therefore frequently used in fuel cells and on the cathode side in PEM electrolyzers. Previously, carbon materials have not been used extensively on the anode side of PEM electrolyzers due to not being sufficiently stable. However, carbon materials that are coated with corrosion-resistant coatings such as the coating 230 described here can be used also on the anode side. Thus, the plurality of elongated nanostructures 220 may comprise elongated carbon nanostructures. Elongated carbon nanostructures may for example be any of carbon nanofibers, carbon nanotubes, carbon nanowires, and carbon nanowalls.

The carbon nanostructures may be between 3 and 10 micrometers in length.

According to some examples, the carbon nanostructures are between 50 and 100 nanometers in width. According to other examples, the carbon nanostructures are between 5 and 20 nm in width or between 15 and 50 nm in width, e.g. if the carbon nanostructures are carbon nanotubes.

The shape and structure of elongated carbon nanostructures can be altered by adjusting the conditions under which the nanostructures are grown, so as to obtain e.g., a desired density or shape of the nanostructures, a desired thickness or length of the nanostructures or a desired number of nanostructures per surface area. Carbon nanofibers and nanowires in particular have the advantage of a high stiffness and rigidity, making them less likely to be deformed if the electrolyzer is assembled by a method such as pressing the components together, and more likely to remain in a desired orientation relative to other components such as the porous layer 210.

The plurality of elongated nanostructures 220 may be vertically oriented, that is, they may extend generally along respective axes, where the axes are oriented in parallel to each other and extend perpendicularly to the porous layer 210. For the nanostructures to extend perpendicularly to the porous layer 210 is herein taken to mean that they extend perpendicularly to an overall plane of extension of the porous layer 210, rather than extending perpendicularly to the part of the surface to which they are attached. The plane of extension of the porous layer can be defined by noting that the porous layer will be a planar element. A planar element has two large bounding surfaces that are often substantially parallel to each other and typically form the two largest bounding surfaces of the element. These bounding surfaces can be referred to as the first and second side of the element. The thickness of the element in a direction perpendicular to these bounding surfaces is generally much less than the extent of the layer in any direction along the bounding surfaces. The plane of extension of the element can be defined as a plane that is substantially parallel with at least one of the two large bounding surfaces.

Thus, according to one example, the plurality of elongated nanostructures 220 may comprise carbon nanofibers and the coating 230 may comprise tantalum oxide and iridium oxide. The iridium oxide may be in the form of nanoparticles.

According to another example, the plurality of elongated nanostructures 220 may comprise carbon nanofibers and the coating 230 may comprise tantalum oxide doped with at least one of iridium, aluminum, hafnium, zirconium or titanium. The coating may also comprise iridium oxide, optionally in the form of nanoparticles.

According to a third example, the plurality of elongated nanostructures 220 may comprise carbon nanofibers and the coating 230 may comprise oxygen-deficient tantalum oxide. The coating 230 may also comprise iridium oxide, optionally in the form of nanoparticles.

Furthermore, the plurality of elongated nanostructures 220 may comprise carbon nanofibers and the coating 230 may comprise hafnium oxide and iridium oxide.

Alternatively, the plurality of elongated nanostructures 220 may comprise carbon nanofibers and the coating 230 may comprise oxygen-deficient hafnium oxide. The coating 230 can also comprise iridium oxide, optionally in the form of nanoparticles.

With reference to FIGS. 1 and 2, there is also herein disclosed an electrolyzer 100 comprising a first electrode 110 and a second electrode 120 and an ion exchange membrane 130 arranged between the first and the second electrode. Each electrode comprises an electrocatalyst layer 111, 121 arranged facing the ion exchange membrane 130, a transport layer 112, 122 arranged facing the respective electrocatalyst layer 111, 121, and a separator element 113, 123 arranged facing the respective transport layer 112, 122. At least one of the first and second electrodes comprises a transport layer arrangement 200 as described above.

In the electrolyzer, the transport layer arrangement 200 will be arranged so that the plurality of elongated nanostructures 220 faces the ion exchange layer 130, thereby acting as a catalyst support.

According to one example, the electrocatalyst is deposited on the ion exchange membrane. The transport layer arrangement 200 is subsequently arranged adjacent to the ion exchange membrane such that the plurality of elongated nanostructures 220 come into contact with the electrocatalyst, thereby providing improved electrical and mechanical contact between the electrocatalyst and the transport layer.

According to another example, the electrocatalyst is comprised in the coating 230, e.g. in the form of iridium oxide nanoparticles. In this case, no electrocatalyst needs to be deposited onto the ion exchange membrane 130, but instead the transport layer arrangement is arranged so that the coating 230 comprising the electrocatalyst comes into contact with the ion exchange membrane 130. Optionally, at least some of the elongated nanostructures 220 comprised in the transport layer arrangement 200 may extend past the surface of the ion exchange membrane 130. That is, the elongated nanostructures 220 may be at least partially embedded in the ion exchange membrane. This embeds the electrocatalyst into the ion exchange membrane 130, which improves contact between the electrocatalyst and the membrane and allows for a more efficient use of the electrocatalyst. A schematic illustration is found in FIG. 4.

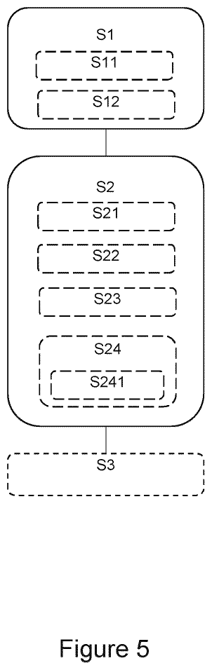

FIG. 5 is a flowchart illustrating a method for producing a transport layer arrangement 200 for the anode of a proton exchange membrane water electrolyzer 100. With reference also to FIGS. 2 and 3 A-D, the transport layer arrangement comprises a porous layer 210. The method comprises generating S1 a plurality of elongated nanostructures 220. Each elongated nanostructure 220 is attached to a first surface of the porous layer 210 at one end of the elongated nanostructure. The method also comprises depositing S2 a coating 230 on the plurality of elongated nanostructures 220, wherein the coating 230 comprises a first layer 321 comprising a non-noble metal oxide.

According to some aspects, generating S1 a plurality of elongated nanostructures 220 may comprise growing S11 the elongated nanostructures 220 on the first surface of the porous layer 210. That is, the elongated nanostructures 220 can be grown using the porous layer 210 as a substrate. This ensures that the elongated nanostructures 220 will be attached to the porous layer 210.

According to other aspects, generating S1 a plurality of elongated nanostructures 220 may comprise growing S12 the elongated nanostructures 220 on a growth substrate and subsequently transferring the elongated nanostructures 220 to the first surface of the porous layer. The growth substrate may comprise materials such as silicon, glass, stainless steel, ceramics, silicon carbide, or any other suitable substrate material. The growth substrate may also comprise high temperature polymers such as polyimide.

Growing elongated nanostructures on a substrate, such as the porous layer 210 or a separate growth substrate, allows extensive tailoring of the properties of the nanostructures. For example, the height of the nanostructures and the spacing between nanostructures can be tailored. Elongated nanostructures can for example be grown using deposition methods such as chemical vapor deposition.

According to some aspects, growing elongated nanostructures on a substrate may comprise depositing a growth catalyst layer on a surface of the substrate and growing the elongated nanostructures on the growth catalyst layer. Here, a growth catalyst is a substance that is catalytically active and promotes the chemical reactions comprised in the formation of nanostructures.

The growth catalyst may comprise materials such as nickel, iron, platinum, palladium, nickel-silicide, cobalt, molybdenum, gold, or alloys thereof. As an example, the growth catalyst layer may be between 1 and 100 nm thick. As another example, the growth catalyst layer may comprise a plurality of particles of growth catalyst.

Depositing a growth catalyst layer may comprise depositing a uniform growth catalyst layer and introducing a pattern onto the deposited uniform growth catalyst layer. Introducing a pattern onto the deposited uniform growth catalyst layer could comprise altering the thickness of the growth catalyst layer according to a pattern, or selectively removing the growth catalyst layer in some places. Introducing a pattern onto the growth catalyst layer may for example be accomplished through lithographic methods such as colloidal or nanosphere lithography. The patterning of the growth catalyst layer makes it possible to control the number of nanostructures per surface area on the substrate.

Some elongated nanostructures, such as carbon nanowalls, can also be grown on a substrate without the use of an additional growth catalyst.

Growing elongated nanostructures on the growth catalyst layer may comprise heating the growth catalyst layer to a temperature where nanostructures can form and introducing a gas comprising a reactant in such a way that the reactant comes into contact with the growth catalyst layer. Here, the reactant is a chemical compound or mix of chemical compounds that comprises the chemical elements used to form the nanostructure. For a carbon nanostructure, the reactant may comprise a hydrocarbon such as methane or acetylene, or it may comprise carbon monoxide.

Growing elongated nanostructures on a substrate may also comprise depositing a conducting layer on a surface of the substrate. The growth catalyst layer may then be deposited on top of the conducting layer. After growing the elongated nanostructures, parts of the conductive layer that extend between or around the elongated nanostructures may be selectively removed. This removal may for example be accomplished through etching, e.g., plasma etching, pyrolysis etching or electrochemical etching.

The conducting layer electrically grounds the substrate, which is an advantage for certain methods of nanostructure growth such as growth in a plasma. It may also prevent the diffusion of atoms between the growth catalyst layer and the substrate.

According to aspects, the conducting layer may be between 1 and 100 microns thick. According to other aspects, the conducting layer may be between 1 and 100 nm thick.

According to aspects, additional layers may be present in addition to the substrate, the growth catalyst layer, and the conducting layer. The materials comprised in the additional layers may be selected to tune properties of the grown nanostructures, facilitate vertically oriented growth, or otherwise improve the result of the growth process.

Deposition of any layer involved in nanostructure growth, including the conducting layer and the growth catalyst layer, may be carried out by methods such as evaporating, plating, sputtering, molecular beam epitaxy, pulsed laser depositing, chemical vapor deposition, spin-coating, spray-coating, or other suitable methods.

Depositing S2 the coating 230 on the plurality of elongated nanostructures 220 may be carried out using methods such as atomic layer deposition, electroless nanoplating, evaporating, plating, sputtering, molecular beam epitaxy, pulsed laser depositing, chemical vapor deposition, spin-coating, spray-coating, electrochemical deposition, or other suitable methods. In particular, depositing a metal oxide may comprise depositing a metal and subsequently oxidizing the metal to form the oxide.

According to one example, depositing S2 the coating layer 230 on the plurality of elongated nanostructures 220 may comprise depositing S21 a dopant element in the first layer 321. The dopant element is then arranged to increase an electrical conductivity of the non-noble metal oxide.

The first layer 321 comprised in the coating 230 has an inner surface facing towards the plurality of elongated nanostructures 220 and an outer surface facing away from the plurality of elongated nanostructures 220. The concentration of the dopant may be higher at the inner surface than at the outer surface.

According to another example, depositing S2 the coating layer 230 on the plurality of elongated nanostructures 220 may comprise depositing S22 a noble metal oxide in the first layer 321. The noble metal oxide could then be selected to act as an electrocatalyst for the oxygen evolution reaction. Optionally, the noble metal oxide is iridium oxide. The concentration of the noble metal oxide may be higher at the outer surface than at the inner surface.

Depositing S2 the coating 230 on the plurality of elongated nanostructures 220 may also comprise depositing S23 an outer layer 310 on the outer surface of the first layer 321. The outer layer 310 may comprise a noble metal oxide. Optionally, the outer layer 310 may comprise a plurality of nanoparticles comprising a noble metal oxide such as iridium oxide. The nanoparticles may be between 2 and 5 nm in size.

Depositing S2 the coating 230 may also comprise depositing S24 an inner layer 322 arranged between the first layer 321 and the plurality of elongated nanostructures. Depositing S24 the inner layer 322 may comprise depositing S241 one or more sub-layers comprising different materials. The inner layer 322 may be arranged to ensure that the elongated nanostructures 220 are fully covered by the coating 230. The inner layer 322 may also be arranged to improve the electron transport between the first layer 321 and the elongated nanostructures, or to alter the electron band structure of the first layer 321.

The method may also comprise a thermal treatment S3 of the transport layer arrangement 200. The thermal treatment can for example comprise exposing the transport layer arrangement to temperatures between 300 and 1000° C. during an extended period of time. An extended period of time may for example be between one and twelve hours. Preferably, the heat treatment is performed in the presence of inert gases such as nitrogen or argon.

1. A transport layer arrangement for the anode of a proton exchange membrane water electrolyzer, the transport layer arrangement comprising a porous layer and a plurality of elongated nanostructures, each elongated nanostructure being attached to a first surface of the porous layer at one end of the elongated nanostructure, wherein the plurality of elongated nanostructures is covered by a coating, the coating comprising a first layer comprising a non-noble metal oxide, the non-noble metal oxide comprising any of tantalum oxide, hafnium oxide, antimony oxide, titanium oxide, tin oxide, and niobium oxide.

2. The transport layer arrangement according to claim 1, wherein the first layer of the coating comprises a dopant arranged to increase an electrical conductivity of the non-noble metal oxide.

3. The transport layer arrangement according to claim 2, wherein the first layer has an inner surface facing towards the plurality of elongated nanostructures and an outer surface facing away from the plurality of elongated nanostructures, and the concentration of the dopant is higher at the inner surface than at the outer surface.

4. The transport layer arrangement according to claim 1, wherein the non-noble metal oxide comprised in the first layer is non-stoichiometric.

5. The transport layer arrangement according to claim 1, wherein the coating comprises an inner layer arranged between the plurality of elongated nanostructures and the first layer.

6. The transport layer arrangement according to claim 5, wherein the inner layer comprises a material arranged to affect the electron band structure of the non-noble metal oxide comprised in the first layer.

7. The transport layer arrangement according to claim 1, wherein the first layer also comprises a noble metal oxide.

8. The transport layer arrangement according to claim 7, wherein the first layer has an inner surface facing towards the plurality of elongated nanostructures and an outer surface facing away from the plurality of elongated nanostructures, and the concentration of the noble metal oxide is higher at the outer surface than at the inner surface.

9. The transport layer arrangement according to claim 1, wherein the first layer has an inner surface facing towards the plurality of elongated nanostructures and an outer surface facing away from the plurality of elongated nanostructures, and wherein the coating comprises an outer layer arranged on the outer surface of the first layer, the outer layer comprising a noble metal oxide.

10. The transport layer arrangement according to claim 9, wherein the outer layer comprises a plurality of nanoparticles.

11. The transport layer arrangement according to claim 1, wherein the plurality of elongated nanostructures comprises elongated carbon nanostructures.

12. The transport layer arrangement according to claim 1, wherein the porous layer comprises a porous metallic material.

13. An electrolyzer comprising a first electrode and a second electrode and an ion exchange membrane arranged between the first and the second electrode, each electrode comprising an electrocatalyst layer arranged facing the ion exchange membrane, a transport layer arranged facing the respective electrocatalyst layer, and a separator element arranged facing the respective transport layer,
wherein at least one of the first and second electrodes comprises a transport layer arrangement according to claim 1.

14. A method for producing a transport layer arrangement for the anode of a proton exchange membrane water electrolyzer, the transport layer arrangement comprising a porous layer, the method comprising:
generating (S1) a plurality of elongated nanostructures, each elongated nanostructure being attached to a first surface of the porous layer at one end of the elongated nanostructure, and
depositing (S2) a coating on the plurality of elongated nanostructures, wherein the coating comprises a first layer comprising a non-noble metal oxide, the non-noble metal oxide comprising any of tantalum oxide, hafnium oxide, antimony oxide, titanium oxide, tin oxide, and niobium oxide.

15. The method according to claim 14, wherein generating (S1) a plurality of elongated comprises growing (S11) the elongated nanostructures on the first surface of the porous layer.

16. The method according to claim 14, wherein generating (S1) a plurality of elongated nanostructures comprises growing (S12) the elongated nanostructures on a growth substrate and subsequently transferring the elongated nanostructures to the first surface of the porous layer.

17. The method according to claim 14, wherein depositing (S2) of the coating on the plurality of elongated nanostructures is carried out using atomic layer deposition, electroless nanoplating, sputtering, chemical vapor deposition or electrochemical deposition.

18. The method according to claim 14, wherein depositing (S2) the coating layer on the plurality of elongated nanostructures comprises depositing (S21) a dopant element in the first layer, the dopant element being arranged to increase an electrical conductivity of the non-noble metal oxide.

19. The method according to claim 14, wherein depositing (S2) the coating layer on the plurality of elongated nanostructures comprises depositing (S22) a noble metal oxide in the first layer.

20. The method according to claim 14, wherein depositing (S2) the coating on the plurality of elongated nanostructures comprises depositing (S23) an outer layer on the first layer, where the outer layer comprises a noble metal oxide.

21. The method according to claim 14, wherein depositing (S2) the coating comprises depositing (S24) an inner layer arranged between the first layer and the plurality of elongated nanostructures.

22. The method according to claim 14, comprising a thermal treatment (S3) of the transport layer arrangement.
